(19) United States
(12) Patent Application Publication
(10) Pub. No.: US 2026/0319968 A1
(43) Pub. Date: Oct. 15, 2026

(54) SYSTEM AND METHOD FOR ZERO-COPY BINARY DATA EXCHANGE ACROSS MEMORY, PROCESS, AND NETWORK BOUNDARIES USING BARE PROTOCOL

(71) Applicant: Houston Hawkins Haynes, Asheville, NC (US)

(72) Inventor: Houston Hawkins Haynes, Asheville, NC (US)

(21) Appl. No.: 19/631,822

(22) Filed: Mar. 27, 2026

Related U.S. Application Data
(60) Provisional application No. 63/786,247, filed on Apr. 9, 2025.

(51) Int. Cl. G06F 12/1072; G06F 16/215

(52) U.S. Cl. CPC G06F 12/1072; G06F 16/215

(57) ABSTRACT

A system and method for zero-copy binary data exchange across three communication boundaries: within-process memory views, inter-process shared memory regions, and network transport frames. The system extends the BARE (Binary Application Record Encoding) protocol with type-safe memory views, consistent virtual address mapping, hardware-aware memory descriptors, and cross-runtime communication. A Memory View Engine provides struct-based, stack-allocated views into byte buffers without data copying. A Codec System provides encode and decode operations using ULEB128 variable-length encoding and offset-tracked streaming decode. A Shared Memory Manager allocates memory-mapped regions at deterministic virtual addresses computed from region identifiers, ensuring consistent address mapping across processes. A Network Frame Transport provides length-prefixed binary frames with zero-copy payload handling. A Hardware Descriptor System extends the architecture to embedded peripherals and accelerator memory spaces. Schema validation and compatibility analysis support gradual schema evolution across system components.

### CROSS-REFERENCE TO RELATED APPLICATIONS

This Nonprovisional Patent Application claims the benefit of U.S. Provisional Patent Application No. 63/786,247, filed on Apr. 9, 2025, and is directed to the subject matter disclosed therein, the contents of which are hereby incorporated by reference.

### FIELD OF THE INVENTION

The present invention relates to systems and methods for binary data exchange that eliminate copy operations across three communication boundaries: within-process memory mapping, inter-process communication, and network transport. More particularly, the invention pertains to a protocol engine built on the BARE (Binary Application Record Encoding) specification that provides type-safe, zero-copy data access through struct-based memory views, offset-tracked decoding, consistent virtual address mapping for shared memory regions, and length-prefixed frame transport, with platform-abstracted interfaces supporting native compiled code, managed runtime environments, embedded hardware peripherals, and GPU/accelerator memory spaces.

### BACKGROUND OF THE INVENTION

### Serialization Overhead in Data Exchange

Modern computing systems routinely exchange structured data between components that may reside in the same process, in separate processes on the same machine, or on separate machines connected by a network. Established serialization protocols such as Protocol Buffers, JSON, MessagePack, and Apache Thrift encode structured data into byte sequences for transmission and decode them at the receiver. Each of these protocols requires at least one copy operation during encoding (marshaling structured data into a byte buffer) and at least one copy operation during decoding (unmarshaling the byte buffer into structured data). For Protocol Buffers, the encoding process allocates an output buffer, serializes each field with tag-length-value framing, and produces a byte array that the caller must then transmit. The decoding process allocates a new message object, parses the byte array, and populates fields by copying values from the parsed buffer into the message object's memory. These copy operations impose latency and CPU overhead that becomes significant for large data structures, high-frequency exchanges, and resource-constrained environments.

### Type Safety Loss at Process Boundaries

When data crosses process boundaries through conventional inter-process communication mechanisms (pipes, sockets, shared memory), the type information associated with the data is lost. The sending process serializes a typed structure into an untyped byte stream; the receiving process must independently know the expected type and reconstruct the structure from the byte stream. If the sender and receiver disagree on the data layout (due to version skew, platform differences, or programming errors), the result is silent data corruption. Existing shared memory implementations do not maintain type metadata alongside the shared data, requiring application-level protocols to manage type agreement. The absence of type safety at process boundaries forces developers to implement manual validation logic, which is error-prone and adds overhead that partially negates the performance benefits of shared memory.

### Inconsistent Virtual Address Mapping

Traditional shared memory implementations (POSIX shm_open/mmap on Linux, CreateFileMapping/MapViewOfFile on Windows) map shared regions at virtual addresses selected by the operating system's memory manager. The virtual address assigned to a shared region may differ between participating processes. When shared data structures contain internal pointers (such as linked list nodes, tree structures, or self-referential records), these pointers become invalid in processes that map the region at a different virtual address. Existing systems address this problem through pointer rebasing (adjusting all internal pointers after mapping) or through offset-based addressing (replacing pointers with offsets from the region base). Pointer rebasing requires a full traversal of the shared data structure at map time, adding latency proportional to the structure's complexity. Offset-based addressing requires all code accessing the shared region to perform offset arithmetic on every dereference, adding per-access overhead.

### Heterogeneous Runtime Communication

Modern systems frequently combine components written in different languages and executing on different runtimes. A native compiled component (C, C++, Rust, or natively compiled F#) may need to exchange data with a managed runtime component (.NET CLR, JVM, or JavaScript engine). These runtimes differ in memory layout conventions, garbage collection behavior, calling conventions, and pointer representation. Existing approaches to cross-runtime communication include foreign function interfaces (FFI), which require manual marshaling of data structures between runtime representations; serialization protocols, which impose copy overhead; and language-specific binding generators, which produce glue code that bridges calling conventions but still copy data across the runtime boundary.

### CPU-Accelerator Memory Boundaries

GPU and other accelerator devices maintain separate memory spaces that are not directly addressable from CPU code. Transferring data between CPU and GPU memory requires explicit copy operations through driver APIs (such as CUDA's cudaMemcpy or OpenCL's clEnqueueReadBuffer). These copies are synchronous by default, blocking the CPU until the transfer completes, and introduce latency that can dominate the total execution time for small-to-medium workloads. Unified memory architectures (such as CUDA Unified Memory or AMD HSA) provide a single virtual address space spanning CPU and GPU memory, but still incur page fault overhead when data is accessed from the non-resident side. No existing system provides zero-copy data exchange between CPU and accelerator memory spaces with type safety guarantees derived from the source language's type system.

### SUMMARY OF THE INVENTION

The present invention provides a system and method for zero-copy binary data exchange across three communication boundaries: within-process memory views, inter-process shared memory regions, and network transport frames. The system is built on the BARE (Binary Application Record Encoding) protocol, extended with type-safe memory views, consistent virtual address mapping, hardware-aware memory descriptors, and a platform-abstracted communication layer.

The invention comprises five integrated components. First, a Memory View Engine providing struct-based, stack-allocated views into byte buffers that enable slicing, offset tracking, and sequential write operations without copying the underlying data. Second, a Type-Safe Codec System providing inline-hinted encode and decode operations parameterized by schema types derived from the BARE specification, with ULEB128 variable-length integer encoding and zigzag signed integer encoding for compact wire representation. Third, a Shared Memory Manager that allocates memory-mapped regions at consistent virtual addresses across participating processes, enabling direct pointer dereference of shared data structures without rebasing or offset arithmetic. Fourth, a Network Frame Transport providing length-prefixed binary frames with message type discrimination, unique message identifiers, and request-response correlation for network communication. Fifth, a Hardware Descriptor System providing memory region classification, access mode enforcement, and peripheral register layout definitions for embedded systems and DMA operations.

The system maintains type safety across all three communication boundaries by registering BARE schemas in a Type Registry that validates memory layouts at both compile time and runtime. Schema validation detects cyclic type references, undefined type names, invalid void usage, invalid map key types, and structural invariant violations before any data exchange occurs. Schema compatibility analysis supports forward and backward compatibility checking for schema evolution across software versions.

### BRIEF DESCRIPTION OF THE DRAWINGS

FIG. 1 is a system architecture block diagram showing the overall component organization including the Memory View Engine, Codec System, Shared Memory Manager, Network Frame Transport, Hardware Descriptor System, and Type Registry.

FIG. 2 is a detailed diagram of the Consistent Virtual Address Memory Mapping mechanism showing shared region allocation, address reservation, and multi-process mapping.

FIG. 3 is a diagram of the Type Verification System showing schema registration, compile-time layout validation, and runtime type checking across process and network boundaries.

FIG. 4 is a diagram of the Zero-Copy Data Flow showing the three-phase data path from memory view through IPC shared region to network frame, with zero copy operations at each boundary.

FIG. 5 is a diagram of the Cross-Runtime Communication mechanism showing native-to-managed runtime boundary crossing with automatic foreign function interface binding generation.

FIG. 6 is a diagram of the CPU-to-GPU memory integration showing heterogeneous memory mapping with hardware-enforced protection barriers.

FIG. 7 is a diagram of the Dual-Plane Design showing the separation of control plane (reliability-focused operations) from data plane (performance-optimized operations).

FIG. 8 is a diagram of the BARE Schema Definition and Validation system showing the type hierarchy, wire encoding mappings, and compatibility checking.

### DETAILED DESCRIPTION OF THE INVENTION

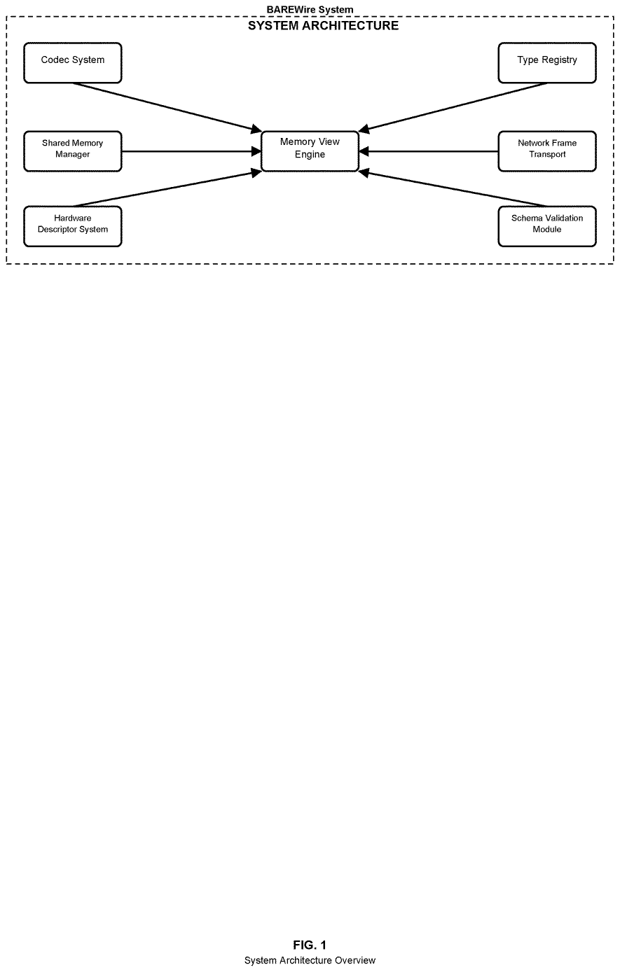

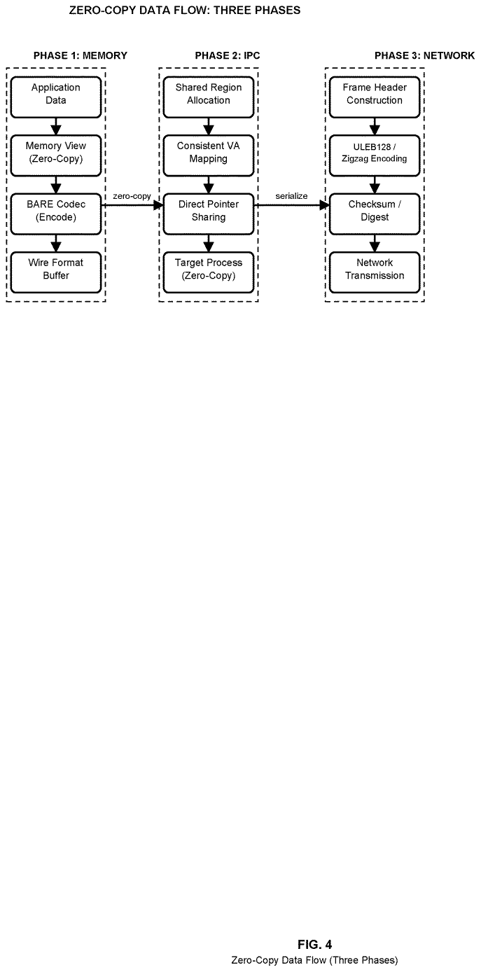

### 1. Memory View Engine (FIG. 1, FIG. 4)

The Memory View Engine provides the foundational abstraction for zero-copy data access within a single process. The engine defines two principal data structures: a Memory view type and a Buffer write type, both implemented as value types (structs) to enable stack allocation and eliminate garbage collector pressure.

The Memory type represents an immutable view into a byte array. It comprises three fields: a reference to the underlying byte array (Data), a starting offset within that array (Offset), and the length of the view in bytes (Length). Creating a Memory view from an existing byte array requires no data copying; the view simply records the array reference and the offset/length bounds. The Memory type supports a slice operation that creates a sub-view by adjusting the offset and length without copying the underlying data. Bounds checking is performed on the offset and length parameters to prevent out-of-bounds access. A copy operation is provided for cases where the caller explicitly requires a data copy, using the platform's optimized block transfer primitive (Array.blit).

The Buffer type represents a mutable sequential write buffer. It comprises two fields: a pre-allocated byte array (Data) and a current write position (Position). The Buffer supports writeByte and writeBytes operations that append data at the current position and advance the position counter. The toMemory operation converts a Buffer to an immutable Memory view without copying: it creates a Memory view referencing the Buffer's byte array with offset zero and length equal to the current position. A remaining operation returns the number of bytes available for writing.

Both types are passed by reference (using the language's byref parameter mechanism) in encode and decode functions. This ensures that the caller's position state is updated in place without creating defensive copies of the struct, which would negate the zero-copy benefit.

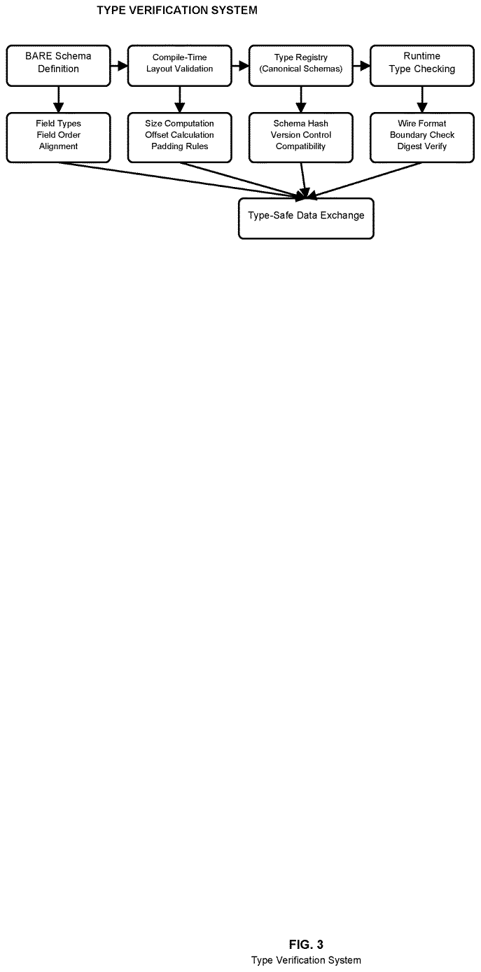

### 2. Type-Safe Codec System (FIG. 1, FIG. 3)

The Codec System provides type-parameterized encode and decode operations for all BARE protocol types. The system is organized around a codec interface parameterized by the value type, with two operations: Encode, which writes a value to a Buffer; and Decode, which reads a value from a Memory view at a given offset and returns both the decoded value and the new offset. The interface is designed for inlining: the compiler can eliminate virtual dispatch overhead by specializing codec implementations at call sites.

The decoder implements the following encoding schemes for primitive types. Unsigned integers use ULEB128 (Unsigned Little-Endian Base 128) variable-length encoding, in which each byte contributes 7 data bits and 1 continuation bit. A value less than 128 occupies a single byte; a 64-bit value occupies at most 10 bytes. The decoder processes bytes sequentially, accumulating 7-bit groups with bit-shift operations, until encountering a byte with a zero continuation bit. Signed integers use zigzag encoding followed by ULEB128: the signed value v is mapped to the unsigned value (v<<1) XOR (v>>63), which maps small-magnitude negative numbers to small unsigned values for compact encoding. Fixed-width integers (8, 16, 32, 64 bits, both signed and unsigned) are read directly from the memory view in little-endian byte order. Floating-point values (32-bit and 64-bit) are read as their bit-level integer representation and reinterpreted as floating-point values. Boolean values occupy a single byte with validation that the byte is exactly 0 or 1.

String values use length-prefixed UTF-8 encoding: a ULEB128-encoded byte count followed by the UTF-8 byte sequence. The decoder supports dual-target compilation: on native compilation targets, strings are stored as UTF-8 byte arrays directly; on managed runtime targets, strings are converted from UTF-8 bytes to the runtime's native string representation. This dual-target support enables the same codec source code to compile to both native executables and JavaScript (via transpilation), maintaining wire-compatible encoding across heterogeneous runtimes.

Aggregate types are composed from primitive codecs. Optional values use a 1-byte tag (0 for absent, 1 for present) followed by the value encoding when present. Lists use a ULEB128 count followed by that many element encodings. Fixed-length lists omit the count prefix, encoding exactly the specified number of elements. Maps use a ULEB128 count followed by alternating key and value encodings. Union (tagged variant) types use a ULEB128 tag identifying the active case followed by the case-specific value encoding. Struct types encode fields in declaration order without any framing between fields.

The decoder returns tuple results (decoded value, new offset) for every decode operation. This offset-tracking pattern enables streaming decode: the caller passes the returned offset as the starting offset for the next decode call. No intermediate buffers are allocated during decode; values are read directly from the Memory view using offset arithmetic.

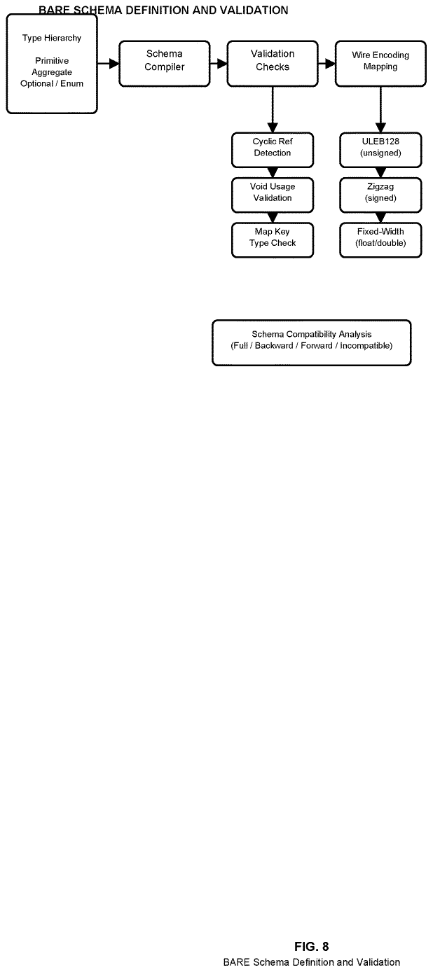

### 3. Schema Definition and Validation System (FIG. 8)

The Schema Definition system provides a declarative type language for defining BARE message schemas. The type system comprises primitive types drawn from a Native Type Universe (NTU) that provides platform-specific size and alignment information; aggregate types including optional, list, fixed-length list, map, union, and struct; and named type references for recursive and shared type definitions.

Each primitive type carries a wire encoding classification: Fixed encoding for types with constant wire size (such as 32-bit integers occupying exactly 4 bytes), VarInt encoding for ULEB128-encoded integers with variable wire size (1 to 10 bytes for 64-bit values), and LengthPrefixed encoding for types whose wire representation begins with a ULEB128 byte count (strings, variable-length data). This classification enables the schema system to compute size bounds for any type: a fixed type has Min=Max=its constant size; a VarInt type has Min=1 and Max=10; a LengthPrefixed type has Min=1 (the minimum ULEB128 count) and Max=unbounded.

The Schema Validation module performs structural correctness checks before any schema is used for encoding or decoding. The validator detects: cyclic type references (where type A refers to type B which refers to type A) using depth-first traversal with a visited set; undefined type names (where a TypeRef references a name not present in the schema's type map); invalid void usage (void/unit types are permitted only within union cases, not as standalone types or struct fields); invalid map key types (map keys must be hashable types; floating-point, void, and variable-length data types are rejected as map keys); and structural invariants including non-empty enums, non-empty unions, non-empty structs, and positive fixed-list lengths.

The Schema Analysis module computes wire format metadata for any schema type. Size calculation recursively computes minimum and maximum byte counts for each type, accounting for the wire encoding classification of primitives and the composition rules for aggregates. Alignment calculation delegates to the NTU platform context, which provides target-specific alignment requirements. The analysis module also performs compatibility checking between schema versions: given an old schema and a new schema, it classifies the relationship as FullyCompatible (all fields present and types match), BackwardCompatible (old fields present with additional new fields), ForwardCompatible (new fields absent with fewer old fields), or Incompatible (type mismatches or removed fields). This compatibility classification enables schema evolution in long-lived systems where different components may use different schema versions.

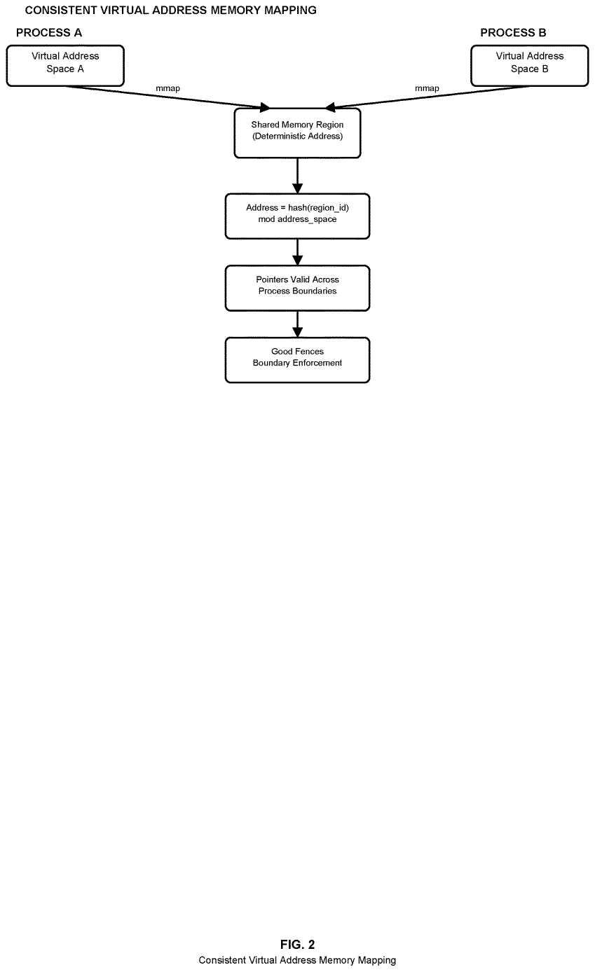

### 4. Shared Memory Manager With Consistent Virtual Address Mapping (FIG. 2)

The Shared Memory Manager provides inter-process data exchange through memory-mapped regions that are allocated at consistent virtual addresses across all participating processes. This consistent mapping eliminates the need for pointer rebasing or offset arithmetic when sharing data structures that contain internal references.

Region creation proceeds as follows. A requesting process invokes the create operation with a region name (a string identifier unique within the system), a size in bytes, and a BARE schema defining the data layout. The Shared Memory Manager allocates a platform-specific shared memory object (POSIX shared memory on Linux, file mapping on Windows) and maps it into the requesting process's virtual address space at a deterministic address. The deterministic address is computed from the region name using a hash function that produces addresses within a reserved virtual address range designated for shared memory regions. This reserved range is selected to avoid conflicts with the process's stack, heap, and code segments.

When a second process opens an existing region by name, the Shared Memory Manager maps the same shared memory object into the second process's virtual address space at the same deterministic address computed from the region name. Because both processes map the region at the same virtual address, any pointer within the shared data structure that references another location within the same region is valid in both processes without adjustment.

The Shared Memory Manager provides field-level access through typed views. Given a schema and a field path (a sequence of field names identifying a location within a nested structure), the getView operation returns a Memory view positioned at the byte offset of the specified field within the shared region. This view can be used with the Codec System's decode operations to read the field value, or with the Buffer's encode operations to write a new value. The view mechanism provides type-safe access without copying the field's data out of the shared region.

Concurrency control is provided through lock and unlock operations that use platform-specific synchronization primitives (POSIX mutexes for Linux, named mutexes for Windows) to serialize access to shared regions. A map operation combines locking, view access, and unlocking into an atomic read-modify-write pattern: it acquires the lock, provides the caller with a view of the region, applies the caller's function to the view, and releases the lock. Region metadata (size, creation time) is accessible through a getInfo operation. Region lifecycle management includes resize (creating a new, larger region and copying the existing data, then updating the name mapping) and close (unmapping and deallocating the platform-specific shared memory object).

### 5. Good Fences Memory Boundary Enforcement

The system implements a “Good Fences” architecture that enforces strict memory boundaries between shared regions and private process memory. Each shared memory region is mapped with page-level protection attributes that restrict access to authorized processes. The Shared Memory Manager verifies process identity before granting map access, using platform-specific process identity mechanisms.

Memory barriers are inserted at critical points in the zero-copy data path to ensure memory ordering consistency across processes. When a writer process modifies data in a shared region, a write barrier ensures that all stores are visible to subsequent reader processes. When a reader process accesses modified data, a read barrier ensures that stale cached values are not used. The specific barrier instructions depend on the target architecture (mfence on x86, dmb on ARM, fence on RISC-V).

The boundary enforcement mechanism prevents three categories of memory safety violations: cross-region access (a pointer in region A referencing data in region B), boundary overflow (a write operation that extends beyond the region's allocated size), and use-after-close (accessing a region that has been unmapped). Cross-region access is prevented by ensuring that all internal pointers within a region are relative to the region's base address. Boundary overflow is prevented by bounds checking in the Memory View Engine's write operations. Use-after-close is prevented by invalidating all views associated with a region when it is closed.

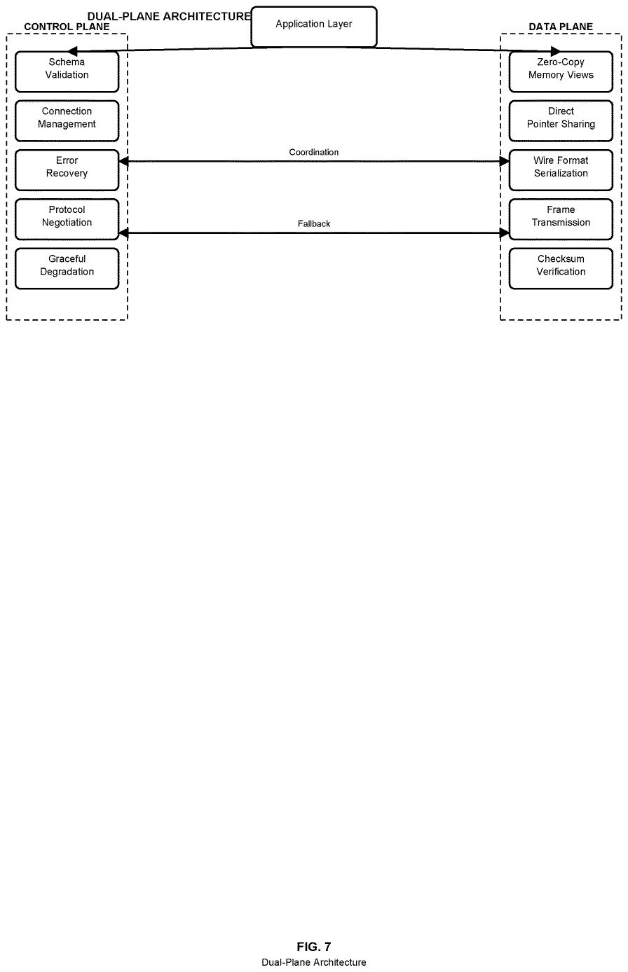

### 6. Network Frame Transport (FIG. 4, FIG. 7)

The Network Frame Transport provides binary frame encoding and decoding for transmitting BARE-encoded data across network connections. Each frame comprises a fixed-size header followed by a variable-length payload.

The frame header contains three fields: a MessageType field (1 byte) discriminating between Request, Response, Notification, and Error message types; a MessageId field (16 bytes) containing a UUID that uniquely identifies the message for request-response correlation; and a PayloadLength field (4 bytes, unsigned 32-bit integer in little-endian byte order) specifying the payload size in bytes.

The frame encoding operation writes the header fields in sequence to a Buffer, followed by the payload bytes. The payload is passed by reference (as a byte array pointer) and written to the Buffer without intermediate copying. The frame decoding operation reads the header fields from a Memory view, extracts a sub-view for the payload (using the Memory type's slice operation, which does not copy data), and returns the decoded frame with the payload accessible as a zero-copy Memory view.

Request-Response correlation is managed through the MessageId field. When a client sends a Request frame, it generates a UUID and includes it in the header. The server's Response frame preserves the same MessageId, enabling the client to match responses to outstanding requests. Notification frames are one-way messages that do not expect a response. Error frames carry an error code and description in the payload.

The frame transport layer interfaces with the Dual-Plane Architecture described in Section 8, where control operations (connection management, message routing, error handling) execute on the control plane with reliability guarantees, while data payloads flow through the data plane with performance-optimized zero-copy handling.

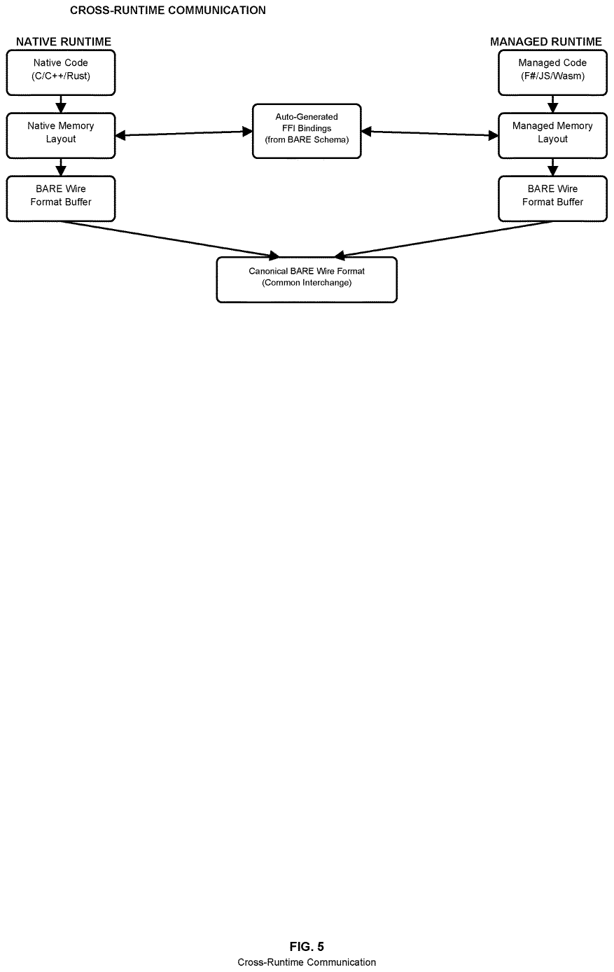

### 7. Cross-Runtime Communication (FIG. 5)

The Cross-Runtime Communication mechanism enables zero-copy data exchange between components executing in different runtime environments. The preferred embodiment supports communication between natively compiled code (produced by compilers targeting machine code through MLIR and LLVM) and managed runtime code (executing on .NET CLR, JVM, or JavaScript engines via transpilation).

The mechanism operates through a Cross-Runtime Adapter that generates foreign function interface bindings from the BARE schema. Given a schema defining a data structure, the adapter produces: for the native side, a C-compatible function signature with pointer parameters referencing the shared memory region; for the managed side, a platform invoke (P/Invoke on .NET, JNI on JVM, or N-API on Node.js) declaration that marshals the managed call to the native function signature.

The key innovation in cross-runtime communication is that the BARE wire format serves as the canonical memory layout for both sides. Native code writes structured data to a shared buffer using the BARE encoder, producing a byte sequence in a known layout. Managed code reads the same buffer using the BARE decoder, interpreting the byte sequence according to the same schema. Because both sides use the same encoding, no format conversion or representation adaptation is required at the runtime boundary. The shared buffer can be a region of shared memory (for same-machine communication) or a network frame payload (for cross-machine communication).

The adapter also handles calling convention differences. Native compiled functions use the platform's C calling convention (cdecl on x86, AAPCS on ARM). Managed runtime calls use their own calling conventions (.NET uses a CLR-specific convention, JVM uses its own). The adapter generates the appropriate marshaling prologue and epilogue to bridge these conventions, including: argument layout adjustment (reordering or padding arguments to match the target convention), return value handling (translating between register returns and stack returns), and exception propagation (translating between native error codes and managed exceptions).

### 8. Dual-Plane Architecture (FIG. 7)

The Dual-Plane Architecture separates data exchange operations into a Control Plane and a Data Plane. The Control Plane handles reliability-focused operations: connection establishment, schema negotiation, region lifecycle management, error detection and recovery, and access control enforcement. The Data Plane handles performance-focused operations: zero-copy buffer access, frame encoding/decoding, and memory barrier insertion.

The Control Plane maintains a registry of active shared memory regions, their associated schemas, and the set of processes authorized to access each region. When a process requests access to a shared region, the Control Plane verifies the process's authorization, validates that the process's schema version is compatible with the region's schema (using the Schema Analysis module's compatibility checker), and returns a handle to the Data Plane for zero-copy access.

The Data Plane provides direct memory access to shared regions through the Memory View Engine. Once the Control Plane has authorized access and validated schema compatibility, the Data Plane provides a Memory view or Buffer positioned at the appropriate offset within the shared region. All subsequent read and write operations proceed through the Data Plane without Control Plane involvement, minimizing latency for the common case.

For network communication, the Control Plane handles connection management (TCP handshake, TLS negotiation), message routing (mapping incoming messages to registered handlers), and error handling (detecting connection failures, retrying failed transmissions). The Data Plane handles frame encoding and decoding, using the Network Frame Transport's zero-copy frame operations to avoid copying payload data during transmission and reception.

The separation of planes enables independent scaling and optimization. The Control Plane can be implemented with conservative, well-tested code that prioritizes correctness, since it handles infrequent operations (connection setup, schema changes). The Data Plane can be implemented with aggressive optimization techniques (lock-free data structures, SIMD encoding, memory-mapped I/O) since it handles high-frequency operations (individual data reads and writes).

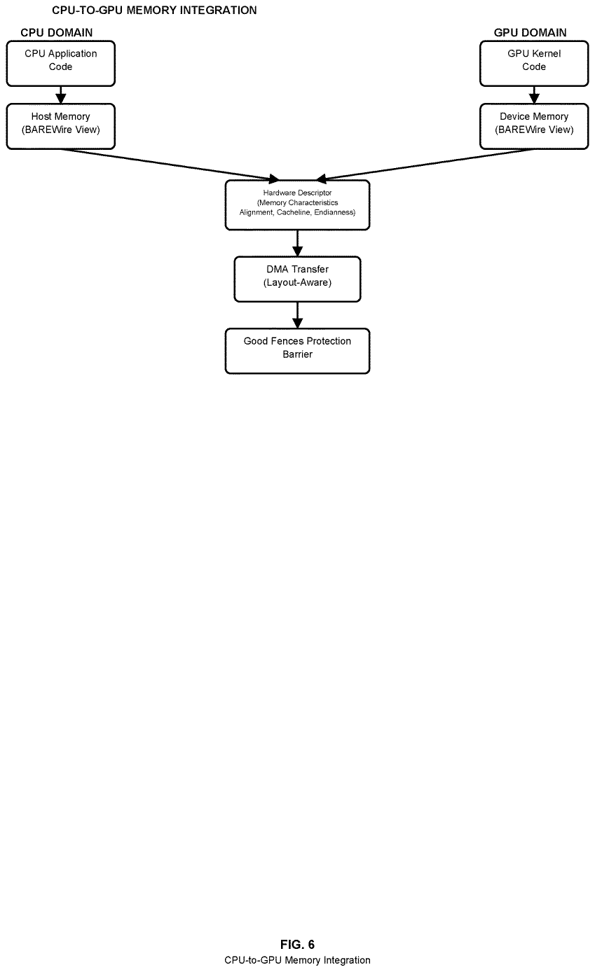

### 9. Hardware Descriptor System for Embedded and Accelerator Targets (FIG. 6)

The Hardware Descriptor System extends the zero-copy architecture to embedded systems and hardware accelerator targets by providing memory region classification, access mode enforcement, and peripheral register layout definitions.

Memory regions are classified into six categories reflecting ARM Cortex-M memory map conventions: Flash (read-only code and constant storage), SRAM (normal read-write RAM, cacheable), Peripheral (memory-mapped I/O registers, volatile), SystemControl (ARM core peripherals such as NVIC and SysTick, volatile), DMA (DMA-accessible memory regions), and CCM (core-coupled memory with single-cycle access). Each category carries derived properties: volatility (Peripheral and SystemControl regions are volatile; Flash and SRAM are non-volatile), cacheability (Flash, SRAM, and CCM are cacheable; Peripheral and SystemControl are not), and executability (Flash and SRAM are executable; Peripheral is not).

Access modes follow CMSIS (Cortex Microcontroller Software Interface Standard) conventions: ReadOnly (_I) for hardware status registers that can only be read, WriteOnly (_O) for hardware command registers where reads return undefined values, and ReadWrite (_IO) for general-purpose registers. These access modes are enforced at compile time by the type system: an attempt to write to a ReadOnly register or read from a WriteOnly register produces a type error.

Peripheral layouts define the register structure of memory-mapped peripherals. Each register is described by its byte offset from the peripheral base address, its NTU (Native Type Universe) type (typically u32 for 32-bit ARM peripherals), its access mode, and an optional set of bit field descriptors. Bit field descriptors specify named sub-fields within a register, each with a bit position, bit width, and access mode. This enables type-safe, named access to individual bit fields within hardware registers, replacing error-prone manual bit manipulation with structured field operations.

Peripheral descriptors map logical peripheral names to physical base addresses. A peripheral with multiple instances (such as GPIO ports A through H) defines a mapping from instance names to base addresses. The descriptor system validates at compile time that the specified base addresses fall within the correct memory region category (GPIO base addresses must be in the Peripheral region, not in Flash or SRAM).

For CPU-to-GPU memory integration, the Hardware Descriptor System extends memory region classification to include GPU-accessible memory categories. Shared memory regions designated for CPU-GPU exchange are mapped with appropriate cache coherency attributes and hardware protection barriers. The DMA category supports zero-copy transfers between CPU memory and DMA-accessible peripheral regions, enabling sensor data to flow from hardware peripherals through the BARE codec directly into shared memory regions without intermediate copies.

### 10. Three-Phase Zero-Copy Data Path (FIG. 4)

The complete zero-copy data path spans three communication phases, each eliminating copy operations through specific mechanisms.

Phase 1 (Memory): Within a single process, the Memory View Engine provides zero-copy access to byte buffers through struct-based views. Creating a view from a byte array records the array reference and bounds without copying data. Slicing a view adjusts offset and length without copying. Converting a Buffer to a Memory view shares the underlying array without copying. All decode operations read values directly from the view's backing array using offset arithmetic. All encode operations write values directly to the buffer's backing array at the current position. The struct-based implementation enables stack allocation of view and buffer objects, avoiding heap allocation and garbage collection overhead.

Phase 2 (Process): Between processes on the same machine, the Shared Memory Manager maps a shared region at consistent virtual addresses in all participating processes. Once mapped, processes access the shared data through Memory views positioned within the shared region. A writer process creates a Buffer backed by the shared region's memory, encodes structured data using the BARE codec, and signals completion through the synchronization mechanism. A reader process creates a Memory view of the shared region and decodes the structured data using the BARE codec. At no point is data copied between process address spaces; both processes access the same physical memory pages through their respective virtual address mappings.

Phase 3 (Network): Between machines connected by a network, the Network Frame Transport encodes a header followed by a payload into a transmission buffer. The payload bytes are written to the buffer by reference (using the Buffer's writeBytes operation, which calls the platform's block transfer primitive for the payload but does not allocate a separate payload copy). On the receiving side, the frame decoder extracts a Memory view of the payload (using the slice operation, which does not copy data) and passes it to the BARE codec for decoding. The network transport layer sends the buffer directly to the socket API, which transfers the data to the network interface through DMA without additional copies in the kernel's networking stack (when the operating system supports zero-copy sendmsg or similar capabilities).

### 11. Platform Abstraction Layer

The system defines platform abstraction interfaces for IPC and memory operations, enabling the same application code to execute on different operating systems and in different runtime environments. The IPC interface defines operations for creating and opening shared memory regions, reading and writing named pipes, and managing region lifecycle. The memory interface defines operations for locking and unlocking memory regions. Platform-specific implementations of these interfaces are provided for POSIX systems (Linux, macOS), Windows, and embedded RTOS environments.

The platform abstraction layer also supports testing through mock implementations. Mock IPC and memory providers simulate shared memory regions using in-process data structures (dictionaries of byte arrays) and simulate named pipes using concurrent queues. This enables comprehensive testing of the zero-copy data path without requiring platform-specific shared memory infrastructure. The mock implementations use pinned memory handles to provide stable addresses for shared region simulation, enabling address-based testing of the consistent virtual address mapping mechanism.

### 12. Schema Evolution and Multi-Version Support

The system supports schema evolution through the Schema Analysis module's compatibility checking mechanism. When a schema is modified (fields added, fields removed, or types changed), the compatibility checker classifies the modification as one of four levels: FullyCompatible (safe for both old readers and new readers), BackwardCompatible (old readers can read new data; new readers may not read old data), ForwardCompatible (new readers can read old data; old readers may not read new data), or Incompatible (neither direction is safe).

The Shared Memory Manager's Control Plane uses compatibility information during the map operation. When a process requests access to a shared region, the Control Plane compares the process's schema version against the region's schema version. If the versions are FullyCompatible, access is granted without restriction. If BackwardCompatible or ForwardCompatible, access is granted with a warning indicating which fields may be absent or unrecognized. If Incompatible, access is denied and the process receives a diagnostic identifying the specific incompatibilities.

This compatibility mechanism enables gradual system upgrades where different components may be updated at different times. A system comprising multiple processes sharing data through the Shared Memory Manager can upgrade individual processes to new schema versions without requiring simultaneous deployment of all components.

What is claimed is:

1. A system for zero-copy binary data exchange across memory, process, and network boundaries, comprising:
a. a memory view engine providing struct-based, stack-allocated views into byte buffers, said views supporting slicing and offset tracking without copying underlying data;
b. a type-safe codec system providing inline-hinted encode and decode operations parameterized by schema types conforming to the BARE (Binary Application Record Encoding) specification, with variable-length integer encoding and offset-tracked streaming decode;
c. a shared memory manager configured to allocate memory-mapped regions at deterministic virtual addresses computed from region identifiers, such that all participating processes map a given region at the same virtual address;
d. a network frame transport providing length-prefixed binary frames with message type discrimination and unique message identifiers, wherein frame payloads are written and read by reference without intermediate copying;
e. a type registry configured to store BARE schema definitions and to validate memory layouts at compile time and runtime; and
f. a schema validation module configured to detect cyclic type references, undefined type names, invalid void usage, and invalid map key types before any data exchange occurs.

2. The system of claim 1, wherein the memory view engine defines a Memory type as a value type comprising a reference to a byte array, an offset, and a length, such that creating a view or sub-view does not copy the underlying byte array.

3. The system of claim 1, wherein the codec system encodes unsigned integers using ULEB128 variable-length encoding and signed integers using zigzag encoding followed by ULEB 128, producing compact wire representations of 1 to 10 bytes for 64-bit values.

4. The system of claim 1, wherein the shared memory manager computes deterministic virtual addresses from region identifiers using a hash function that produces addresses within a reserved virtual address range, enabling consistent mapping across independent processes.

5. The system of claim 1, further comprising a memory boundary enforcement mechanism that inserts architecture-specific memory barriers at write and read points in the memory-mapped regions to ensure memory ordering consistency across the participating processes.

6. The system of claim 1, further comprising a cross-runtime adapter configured to generate foreign function interface bindings from the BARE schema definitions stored in the type registry, enabling zero-copy data exchange between natively compiled code and managed runtime code using the BARE wire format as the canonical memory layout for both sides.

7. The system of claim 1, further comprising a hardware descriptor system defining memory region classifications including at least volatile peripheral regions, cacheable RAM regions, and DMA-accessible regions, with compile-time enforcement of access mode constraints.

8. The system of claim 1, further comprising a dual-plane architecture separating control operations from data operations, wherein a control plane manages region lifecycle, schema negotiation, and access authorization, and a data plane provides direct memory access through the memory view engine.

9. The system of claim 1, further comprising a schema compatibility analysis module configured to classify schema modifications as fully compatible, backward compatible, forward compatible, or incompatible, enabling gradual schema evolution across system components.

10. The system of claim 1, wherein the codec system supports dual-target compilation, producing wire-compatible encoding from the same source code when compiled to native machine code and when transpiled to JavaScript.

11. A method for zero-copy binary data exchange across memory, process, and network boundaries, comprising:
a. defining a schema conforming to the BARE specification, the schema specifying structured data types with wire encoding classifications;
b. validating the schema for structural correctness including absence of cyclic type references and undefined type names;
c. for within-process data access, creating struct-based memory views into byte buffers that reference the underlying data without copying;
d. for inter-process data exchange, allocating a shared memory region at a deterministic virtual address computed from a region identifier, and mapping said region at the same deterministic address in each participating process;
e. for network data exchange, encoding structured data into length-prefixed binary frames with message type discrimination, writing payload bytes by reference without intermediate copying; and
f. decoding received data using offset-tracked streaming decode that reads values directly from the memory view without allocating intermediate buffers.

12. The method of claim 11, further comprising enforcing memory boundaries at edges of the shared memory region using architecture-specific memory barriers and bounds checking on write operations to the shared memory region.

13. The method of claim 11, further comprising generating foreign function interface bindings from the schema defined in step (a) to enable cross-runtime communication, wherein native and managed code access the same shared memory region using the BARE wire format as a common memory layout.

14. The method of claim 11, further comprising checking compatibility between the schema used by a requesting process and the schema associated with the shared memory region before granting access, and denying access when the schemas are incompatible.

15. The method of claim 11, wherein computing the deterministic virtual address in step (d) comprises applying a hash function to the region identifier to select addresses within a reserved virtual address range that avoids conflicts with process stack, heap, and code segments.

16. The method of claim 11, further comprising providing typed field-level access to the shared memory region through schema-derived field paths, wherein each field path identifies a location within a nested structure defined by the schema and returns a memory view positioned at the corresponding byte offset.

17. The method of claim 11, further comprising defining hardware memory descriptors that classify memory regions by volatility, cacheability, and executability, and enforcing access mode constraints at compile time for memory-mapped peripheral registers based on said hardware memory descriptors.

18. A non-transitory computer-readable medium storing instructions that, when executed by a processor, cause the processor to:
a. maintain a type registry of BARE schema definitions with validation for structural correctness;
b. provide within-process zero-copy data access through struct-based memory views that reference byte buffers without copying;
c. allocate shared memory regions at deterministic virtual addresses computed from region identifiers, ensuring consistent address mapping across participating processes;
d. encode and decode structured data using type-parameterized codecs with ULEB128 variable-length integer encoding and offset-tracked streaming decode;
e. transport encoded data across network connections using length-prefixed binary frames with zero-copy payload handling; and
f. enforce memory boundaries at shared region edges using memory barriers and bounds checking.

19. The non-transitory computer-readable medium of claim 18, wherein the instructions further cause the processor to generate cross-runtime foreign function interface bindings from BARE schemas, enabling zero-copy data exchange between natively compiled code and managed runtime code.

20. The non-transitory computer-readable medium of claim 18, wherein the instructions further cause the processor to perform schema compatibility analysis classifying schema modifications as fully compatible, backward compatible, forward compatible, or incompatible, and to enforce compatibility requirements during shared region access.
